(19) United States
(12) Patent Application Publication
(10) Pub. No.: US 2006/0015776 A1
(43) Pub. Date: Jan. 19, 2006

(54) Built-in computer power-on memory test method

(76) Inventor: Yu-Mei Lee, Jhonghe City (TW)

Correspondence Address: Yu-Mei Lee, P.O. Box No. 6-57, Junghe, Taipei, 235, TW

(21) Appl. No.: 10/892,210

(22) Filed: Jul. 16, 2004

(51) Int. Cl. G06F 11/00

(52) U.S. Cl. 714/30

(57) ABSTRACT

A built-in computer power-on memory test method, wherein a memory test program is built into the BIOS unit of the motherboard, immediately displays a menu on the screen at computer power-on, with the menu showing at least the commands of “Press DEL to enter SETUP” and “Press CTRL to Memory Test.” When users press the “CTRL” key, the aforementioned memory test program will be invoked, and automatically perform test to the DRAM on the motherboard, whereby quickly and accurately providing the high quality DRAM usage that is compatible with the motherboard, and thus promoting the stable operation of that computer system.

### BACKGROUND OF THE INVENTION

a) Field of the Invention

The present invention relates to a built-in computer power-on memory test method, and more particularly to a method that immediately displays a menu on the screen at computer power-on, and allows users to follow the instruction on the menu to select the DRAM test, select the basic setup of the motherboard, or make no selection to enter the operating system, in order to accomplish the general power-on operation.

Accordingly, the present invention can select the DRAM test at power-on in order to ascertain that the memory is compatible with the motherboard, and that the availability and the size of the memory are sufficient, whereby assuring the stable operation of that computer system.

b) Description of the Prior Art

The conventional DRAM test at computer power-on uses a simple but not complete method. As the computer is getting faster and faster, the design of the motherboard and memory is more and more complex, causing the issue of compatibility between the motherboard and memory to be more severe. Therefore, the aforementioned simple memory test is not sufficient for providing a stable operating environment for the whole computer system, and can cause inconvenience to users due to system crash.

Accordingly, this problem needs to be solved, and a brand-new built-in computer power-on memory test method is invented.

### SUMMARY OF THE INVENTION

The primary object of the present invention is to provide a built-in computer power-on memory test method in which a memory test program is built into the BIOS unit of the motherboard, and a menu is immediately displayed on the screen at computer power-on, whereby a complete test to all or part of the DRAM can be performed, in order to confirm the compatibility of the memory with the motherboard, whereby achieving the stable operation of the computer system.

To achieve the aforementioned object, a memory test program will be built into the BIOS unit of the motherboard, and immediately display a menu on the screen at computer power-on. The menu will include at least the commands of “Press DEL to enter SETUP” and “Press CTRL to Memory Test” (which can be replaced with other function keys), as well as the functions of memory block setup, audio setup, selection of the display mode of test results, test pattern setup, and exit test, which are under the memory test environment and will be configured and controlled with the specific function keys.

According to the present invention, users can press the “CTRL” key from the menu shown on the screen at computer power-on and the aforementioned memory test program will be invoked. Based on the settings of various function keys, the aforementioned memory test program will automatically and continuously perform test to all or part of the DRAM in the computer system, and display the test results on the screen. When the exit test key is pressed, the system will reset and reboot, and the test is accomplished. The test can quickly and accurately provide the high quality DRAM usage that is compatible with the motherboard (that is, immediately checking the availability of the DRAM at computer power-on), whereby promoting the stability of that computer system.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of the architecture of a built-in computer power-on memory test method.

FIG. 2 shows a flow diagram of the memory test mode of a built-in computer power-on memory test method.

FIG. 3 shows a block diagram of the architecture of function key checking as depicted in the flow diagram of FIG. 2.

FIG. 4 shows a main screen of the implementation of the present invention.

FIG. 5 shows another form of test results as depicted in FIG. 4.

FIG. 6 shows a sub screen of executing the F1 key as depicted in FIG. 4.

FIG. 7 shows a sub screen of executing the F2 key as depicted in FIG. 4.

FIG. 8 shows a root screen of executing the F1 key as depicted in FIG. 7.

FIG. 9 shows a root screen of executing the F2 key as depicted in FIG. 7.

FIG. 10 shows a root screen of executing the F3 key as depicted in FIG. 7.

### DETAILED DESCRIPTION OF THE PREFERRED EMBODIMENTS

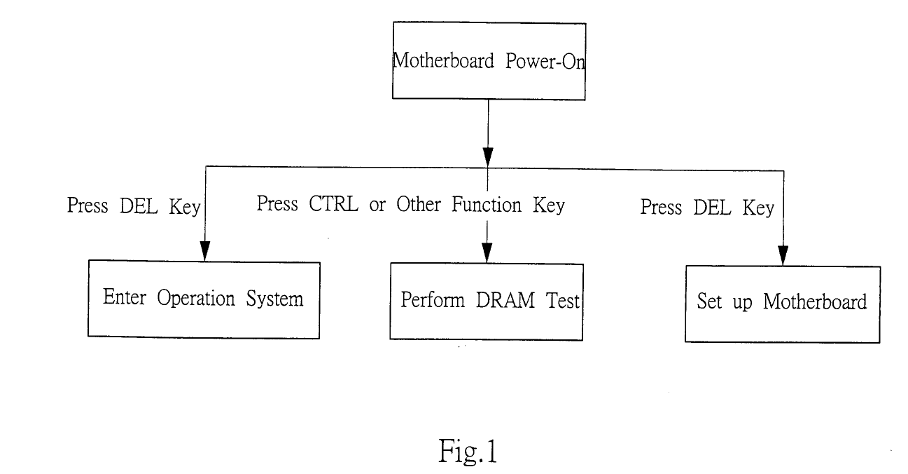

Referring to FIG. 1 to FIG. 3, the present invention “a built-in computer power-on memory test method” includes a DRAM test program built into the BIOS unit of the motherboard. This memory test program will immediately display a menu on the screen at computer power-on, showing at least the commands of “Press DEL to enter SETUP” and “Press CTRL to Memory Test”, as well as the functions of memory block setup, audio setup, selection of display mode of test results, test pattern setup, and exit test, which are under the memory test environment and will be configured and controlled with the specific function keys. Moreover, the aforementioned “DEL” and “CTRL” keys can be replaced with other function keys.

The aforementioned test method includes:

Memory Block Setup

A part (such as within 32 to 64 MB) or all of the memory block from 128 MB to 256 MB of DRAM can be selected for testing.

Audio Setup

The volume of alerter can be turned on/off.

Selection of the Display Mode of Test Results

The test results can be displayed in text or image mode.

Test Pattern Setup

One of the test patterns of RANDOM test, SCAN test, CHECK test, MARCHING test, and WALKING VIT test can be selected for testing.

Exit Test

A specific function key (such as Del or Esc key) can be used to exit the memory test program.

According to the present invention, a menu will be immediately displayed on the screen at computer power-on, and the aforementioned memory test program will be invoked upon pressing the “CTRL” key following the instruction on the menu; on the other hand, the system will directly enter the motherboard setup according to the original boot program (when the “DEL” key is pressed), or enter the operating system (when no key is pressed).

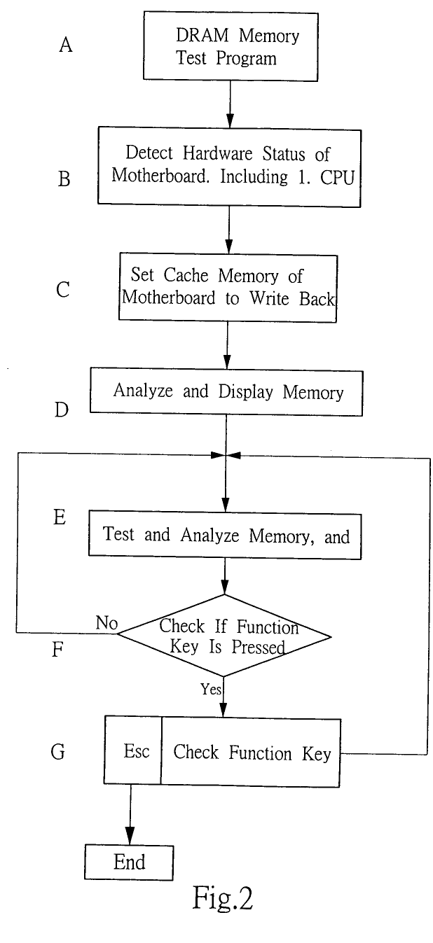

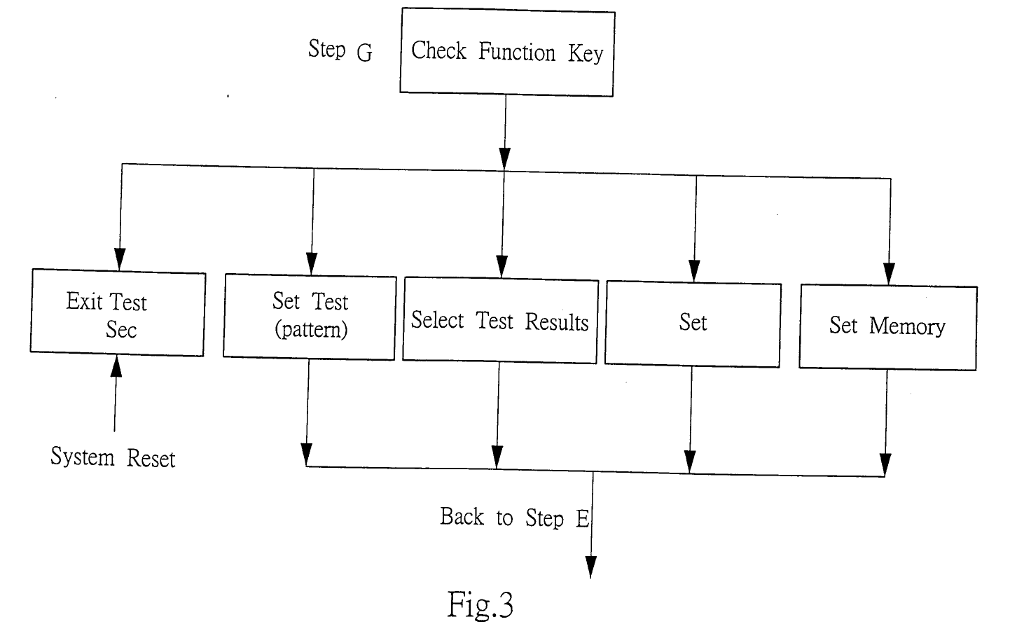

Referring to the flow diagram as depicted in FIG. 2, when the memory test program is invoked, the hardware status (including CPU, memory, and chipset, etc.) of the motherboard will be detected first. Next, the cache memory within the motherboard will be set to write back mode. Then, the DRAM test and analysis will be performed, and the test results will be recorded. Finally, the program will check if any function key is pressed (as shown in FIG. 3). If no key is pressed, the program will return to the previous step of DRAM test, analysis, and recording. If a key is pressed, then based on the settings of various function keys, the memory test program will automatically perform the compatibility and memory size test to all or part of the DRAM in the computer system, and display the test results on the screen. Moreover, the program will return to the aforementioned step of DRAM test, analysis, and recording after the test is accomplished until the exit test key is pressed, and the computer system resets and reboots. This test can quickly and accurately provide the high quality DRAM usage that is compatible with the motherboard, whereby promoting the stable operation of that computer system.

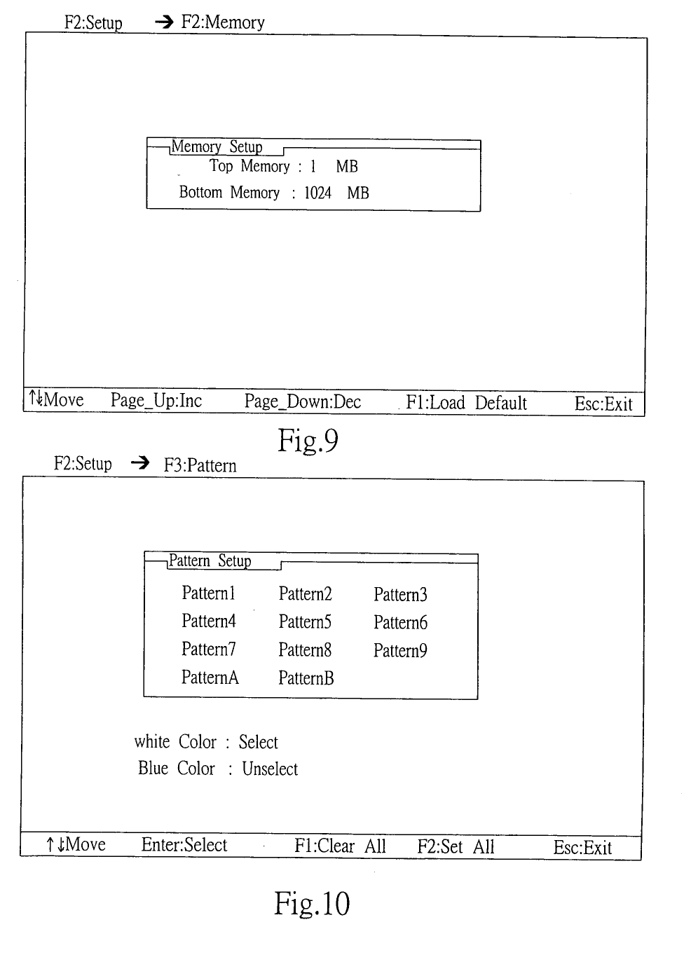

FIG. 9 shows a schematic view of an implementation of the present invention, including:

Name and Version of the Test Program

In addition to the software name and version, there are also the copyright notice and the URL of the creator.

test Status

It includes the test mode, memory channel, test time, test pattern, memory location, and number of test loops.

hardware Information

It includes the CPU speed, DRAM speed, memory size, test scope, and memory time sequence, etc.

Result of Test Loops

It includes the number of loops that passed the memory test, and the number of loops that failed the test.

Test Pattern and Status

It includes several kinds of test patterns (11 patterns in this figure) for users to select, and displayed with different colors: test pattern that is already selected, test pattern that is not yet selected, test pattern for which the test is being performed, test pattern for which the test has been performed, and test pattern for which a problem is found.

test Results

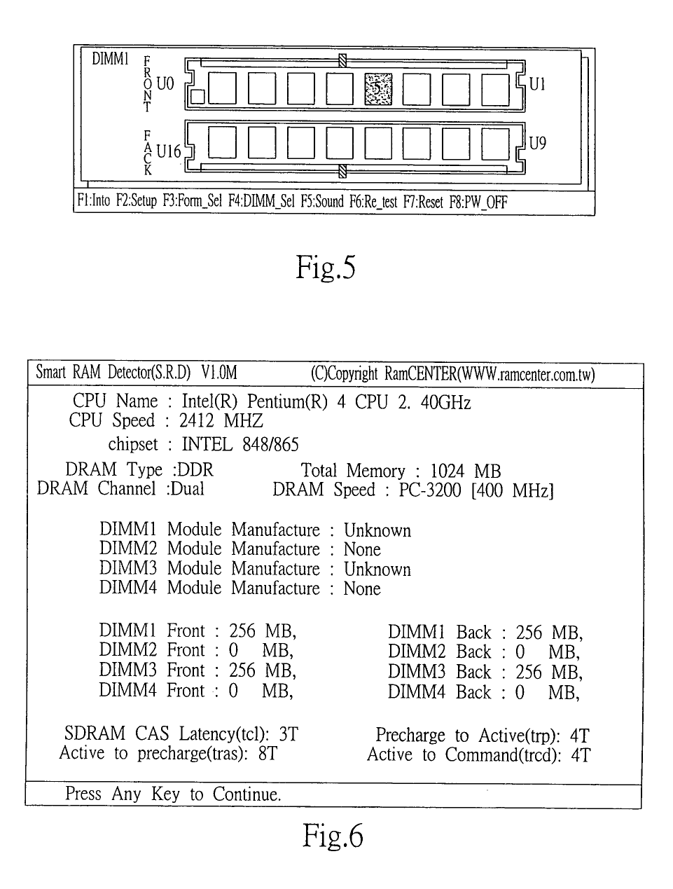

As shown in the first row of DIMM1F:256 MB 00 00 00 . . . , it means that the front memory size of the first slot on the motherboard is 256 MB, and the status of each memory IC on that face. Also as shown in the fourth row of DIMM2B:0 MB 00 00 00 . . . , it means that the back memory size of the second slot on the motherboard is 0 MB (also means no memory). Accordingly, the front and back memory sizes of the slot 1 to slot 8 (or even more) on the motherboard can be displayed individually. Moreover, the function key “F3: Form_set” at the bottom of the main screen can be used to display the test results in memory diagram, with different colors showing the position of the failure memory IC (as shown in FIG. 5).

Function Selection

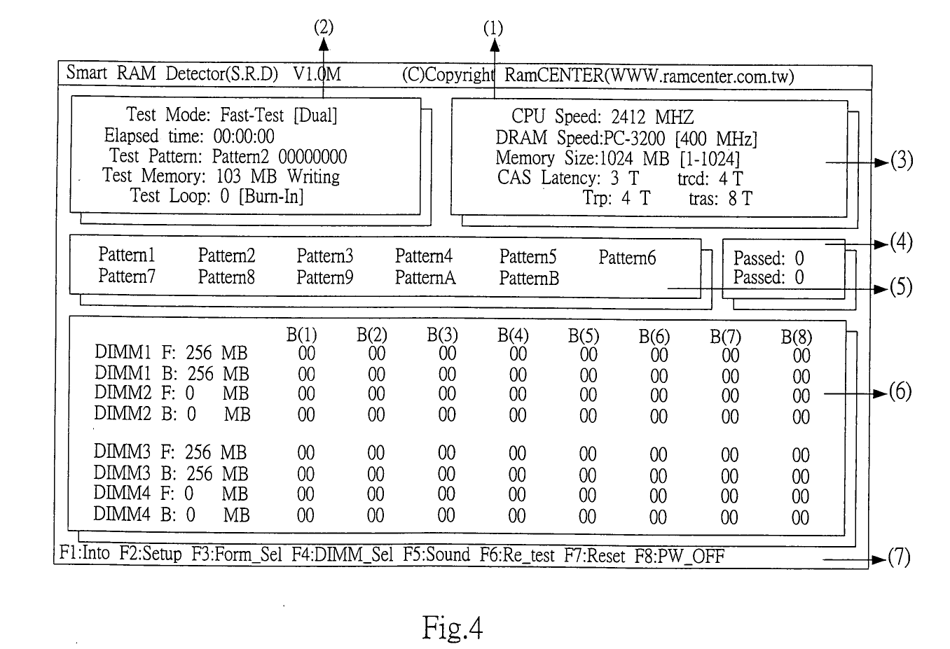

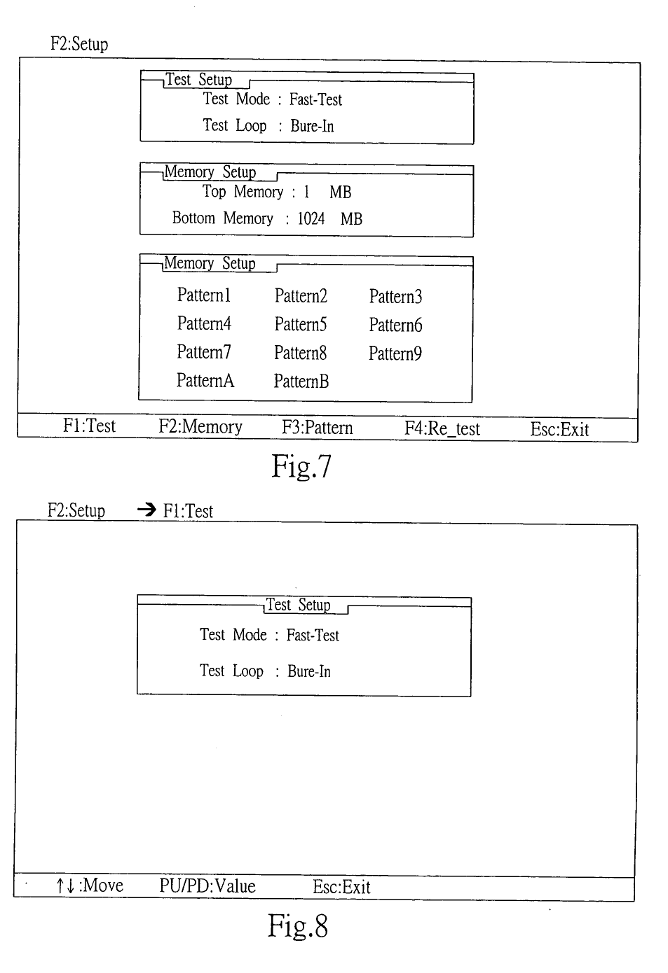

It includes F1 Info (hardware information), F2:Setup (configuration), etc. According to the function displayed at the bottom row of F1˜Fx, users can press the corresponding function key F1˜F12 to quickly execute the task. For example, when users press the F1 key on the main screen of FIG. 4, the Info (hardware information) sub screen will be displayed (as shown in FIG. 6), showing the status information of CPU and other memory. After that, following the instruction at the bottom of the screen, users can press any key to return to the main screen. When users press the F2 key on the main screen, the Setup (configuration) sub screen will be displayed (as shown in FIG. 7). Following the instruction at the bottom of that screen, users can still select F1:Test (test mode setup), F2:Memory (memory block setup), or F3:Pattern (test pattern setup), and enter the corresponding root screen (as shown in FIG. 8 to FIG. 10). Following the instruction at the bottom of those root screens, users can select the rest of functions, until all the required test is accomplished. With this easy operation, users can quickly find out failure memory.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A built-in computer power-on memory test method, wherein a memory test program is built into the BIOS unit of the motherboard, and immediately displays a menu on the screen at computer power-on; the menu includes at least the commands of “Press DEL to enter SETUP” and “Press CTRL to Memory Test”, as well as the functions of memory block setup, audio setup, selection of display mode of test results, test pattern setup, and exit test, which are under the memory test environment, and can be configured and controlled with the specific function keys; following the instruction on the screen, “CTRL” key can be pressed at computer power-on, and the memory test program will be invoked, and testing to all of part of DRAM will be automatically performed, based on the settings of the various function keys; after that, the test results will be displayed on the screen, until the exit test key is pressed, and the system resets and reboots; this test can quickly and accurately provide the high quality DRAM usage that is compatible with the motherboard, whereby promoting the stable operation of that computer system.

2. The built-in computer power-on memory test method according to claim 1, wherein the commands of “Press DEL to enter SETUP” and “Press CTRL to Memory Test” can be replaced with other function keys.
